(19) United States
(12) Patent Application Publication
(10) Pub. No.: US 2003/0042192 A1
(43) Pub. Date: Mar. 6, 2003

(54) Manifold adapted for replaceable fluid filter cartridge

(76) Inventors: Young Sik Nam, Suwon City (KR); Soon Tae Kim, Uiwang City (KR)

Correspondence Address: CHA & REITER, 411 Hackensack Ave, 9th Floor, Hackensack, NJ, 07601, US

(21) Appl. No.: 10/191,191

(22) Filed: Jul. 9, 2002

(30) Foreign Application Priority Data
Sep. 4, 2001 (KR) 2001-54174

(51) Int. Cl. B01D 35/147

(52) U.S. Cl. 210/249; 210/443; 210/420

(57) ABSTRACT

Disclosed is a manifold for a replaceable fluid filter cartridge. The manifold possesses inlet and outlet conduits and a housing. A first valve assembly is provided in the inlet passage. A solenoid of the first valve assembly can be operated under the control of a controller when coupling and decoupling the filter cartridge to and from the manifold. The housing is defined with a flow bore through which water filtered in the filter cartridge can flow and a reservoir in which the filtered water is stored after flowing through the flow bore. One end of the outlet conduit is provided with a chamber. A second valve assembly is provided in the chamber. The second valve assembly includes an electromagnetic valve, and a sealing block is disposed in the chamber. The sealing block is defined with a flow path. A flow path switchover member functions to divert fluid flow through the outlet conduit into a first or second outlet conduit part. The flow path switchover member includes a hollow cylindrical body, a pair of bars, a pair of holes and a stopcock. A spring is placed between the flow path switchover member and a bottom surface of the chamber. When a solenoid of the second valve assembly is in an OFF state, the first outlet conduit part is opened, and when the solenoid is in an ON state, the second outlet conduit part is opened.

### BACKGROUND OF THE INVENTION

1. Field of the Invention

The present invention relates to a manifold to which a replaceable fluid filter cartridge constituting a part of a water purification system is coupled, and more particularly, the present invention relates to a manifold in which inlet and outlet passages are defined in the shape of conduits and fluid-flow controlling devices are provided in the conduits, thereby preventing leakage from water supply lines upon changing the filter cartridge.

2. Description of the Related Art

With the development of living appliances used at home or in offices, etc., demand for water purification and filtration systems to be used in a state wherein they are coupled to the appliances has been gradually increased. A water purification or filtration device serving as one main component element of such water purification and filtration systems typically adopts a replaceable filter cartridge. In this regard, it is the norm that filter cartridges are formed each to have a single or unitary port having multiple flow channels therein, and this type of filter cartridges are disclosed in U.S. Pat. Nos. 4,915,831, 5,336,406 and 5,354,464.

A connecting device or manifold serving as another main component element of the water purification and filtration system functions to receive and transfer fluid such as water to the filter cartridge and direct filtered fluid to desired places inside the appliance. Each of the connecting devices or manifolds such as disclosed in U.S. Pat. Nos. 4,915,831, 5,336,406 and 5,753,107 is provided with a single inlet port and a single outlet port, and the connecting device or manifold such as disclosed in U.S. Pat. No. 5,354,464 is provided with multiple ports.

Meanwhile, it is necessary to periodically change the filter cartridge used in the water purification and filtration system. In this connection, a problem is caused in that leakage may occur in water supply lines upon changing the filter cartridge. In order to prevent leakage from water supply lines upon changing a filter cartridge, as described in U.S. Pat. No. 5,753,107, a flow control valving must be provided to a manifold or the filter cartridge. As the case may be, the filter cartridge can be inadvertently decoupled from a connecting device to cause water leakage. Solutions to cope with this problem are disclosed in U.S. Pat. Nos. 4,915,831 and 5,336,406.

Due to the fact that the conventional water purification and filtration system adopts a configuration that, by rotating the filter cartridge in one direction relative to the connecting device, they are coupled to each other, and by rotating the filter cartridge in the other direction, they are decoupled from each other, coupling and decoupling of the filter cartridge and connecting device to and from each other can be easily effected. In order to ensure that water is supplied from a water supply source such as waterworks or a water tank to the connecting device and flows through the filter cartridge, and filtered water is directed again through the connecting device to a desired place (for example, an ice making section of a refrigerator), a conduit such as a pipe should be provided to join the connecting device and the water supply source with each other. In the conventional art, disadvantages are caused in that, since a screwed type pipe fitting structure is adopted in which pipes are threadedly joined to ports of the connecting device, it is cumbersome and time-consuming to connect, using pipes, an inlet port of the connecting device with the water supply source and an outlet port of the connecting device with the desired place. Because the connecting device and the pipes are joined with each other in this way, when it is necessary to change the pipes due to aging, damage, etc., laborious work must be carried out.

Moreover, in the conventional connecting device, it is considered as an essential point to define inlet and outlet passages for receiving water from the water supply source, transferring water to the filter cartridge and directing the filtered water to the desired place. Therefore, it is difficult to install on the manifold itself a fluid-flow shutoff valve for preventing water leakage upon changing the filter cartridge. Also, even in the case that the fluid-flow shutoff valve is installed on the manifold, the connecting device and the filter cartridge must be designed in such a way as to structurally interact with each other.

Further, in the case that the conventional water purification and filtration system is used in an ice making apparatus, when an amount of fluid flowing through fluid supply lines is decreased due to interruption of fluid supply as it occurs where the filter cartridge is changed with new one, unless fluid flow to the ice making apparatus is completely shut off, defects may result from freezing of water. That is to say, when the filter cartridge is decoupled from the connecting device and thereby fluid supply from the water supply source is interrupted, if fluid flow to the ice making apparatus is not completely shut off and even a small amount of water continuously flows into the ice making apparatus, the fluid supply lines are likely to be frozen, which adversely influences surrounding arrangements.

### SUMMARY OF THE INVENTION

Accordingly, the present invention has been made in an effort to solve the problems occurring in the related art, and an object of the present invention is to provide a pipe or tube connecting structure in which inlet and outlet passages of a manifold are defined by conduits having the shape of pipes or tubes, and the manifold and external pipes are easily jointed with and disjointed from each other.

Another object of the present invention is to provide a manifold in which fluid is allowed to be introduced into and discharged from a housing of the manifold through inlet and outlet passages of the manifold, having the shape of conduits, in a manner such that valve devices can be easily installed on the conduits extending outward from the housing of the manifold.

Another object of the present invention is to provide a manifold in which inlet and outlet passages extending outward from a housing of the manifold are designed to have separate ports or chambers to be connected with valve devices, thereby performing a function of a multi-port connecting device.

Another object of the present invention is to provide a manifold in which a chamber or a reservoir is formed in a housing of the manifold to store a predetermined amount of fluid, thereby managing a fluid amount variation resulting from a fluid pressure change.

Another object of the present invention is to provide a flow control unit which can control a flow rate of fluid supplied from a reservoir defined in a housing of a manifold to an outlet passage, in response to a fluid amount variation in the reservoir.

Still another object of the present invention is to provide a manifold which can prevent leakage out of fluid supply lines upon changing a filter cartridge, and a filter cartridge which is coupled to the manifold.

Yet still another object of the present invention is to provide a manifold which, in the case of being used along with an ice making apparatus, completely shuts off fluid flow to the ice making apparatus when fluid supply is interrupted as it occurs where a filter cartridge is changed with new one, thereby preventing conduits and surrounding arrangements from being damaged due to freezing of water.

The above-described objects and other advantages are achieved by a manifold according to the present invention, which constitutes a water purification and filtration system and possesses inlet and outlet passages having the shape of conduits and a cylindrical housing. The inlet and outlet conduits are formed to extend outward from the housing, and preferably integrated with the housing.

A first valve assembly is provided in a tubular passage of the inlet conduit to control fluid flow. The first valve assembly includes an electromagnetic valve which controls fluid flow in response to an electric signal. A valve body constitutes the first valve assembly in a manner such that a dome-shaped protuberance is formed in the tubular passage of the inlet conduit and an inlet aperture for rendering fluid communication is defined through the dome-shaped protuberance. A solenoid of the first valve assembly can be operated by ON and OFF signals generated by a controller when coupling and decoupling a filter cartridge to and from the manifold, or may be designed to control fluid flow by a separate signaling channel independently of an operation of changing a filter cartridge.

The housing is defined with a flow bore through which water filtered in the filter cartridge can flow and a reservoir in which the filtered water is stored after flowing through the flow bore. Accordingly, the reservoir can appropriately manage a fluid amount variation by storing a predetermined amount of fluid.

One end of the outlet conduit is provided with a port or chamber. A second valve assembly is provided to the chamber, and at this time, the outlet conduit serves as a valve body. The second valve assembly includes an electromagnetic valve, and a sealing block is disposed in the chamber. The sealing block generally has a drum-shaped configuration, and an annular recess is defined on a circumferential outer surface of the sealing block. The sealing block is defined with a pair of guide holes which extend in a longitudinal direction and a T-shaped flow path. A flow path switchover member functions to divert fluid flow through the outlet conduit into a first or second outlet conduit part. The flow path switchover member includes a hollow cylindrical body, a pair of bars, a pair of holes and a stopcock. A spring is placed between the flow path switchover member and a bottom surface of the chamber. When a solenoid of the second valve assembly is in an OFF state, the spring supports the sealing block and the flow path switchover member against elastic force of another spring which is disposed in the solenoid.

The first and second valve assemblies are controlled by the controller in a manner such that they allow fluid flow to be effected in a predetermined direction unless interrupt signals are applied to them. For example, by maintaining the first valve assembly at an ON state and the second valve assembly at an OFF state using a signaling channel, a normal flowing direction of fluid discharged from the chamber of the outlet conduit can be maintained as it is. In this regard, it is to be readily understood that fluid flow can be effected in another direction by energizing the solenoid of the second valve assembly through application of a separate interrupt signal which is outputted from the controller.

Fluid flow in the normal direction is ensured by the fact that, when the sealing block and the flow path switchover member are assembled with each other and disposed in the chamber, unless the separate interrupt signal is applied to the solenoid of the second valve assembly, the flow path switchover member, for example, always closes the T-shaped flow path of the sealing block and opens an outlet aperture which is defined through the valve body to be communicated with the chamber. Due to fluid flow in the normal direction, when the manifold according to the present invention is used along with an ice making apparatus, it is possible to prevent freezing of water. Further, it is to be noted that the normal fluid flow direction is determined by a relationship between outlet ports and devices using fluid.

Flow control means is provided in the reservoir of the housing or the outlet conduit and includes a flow control unit. The flow control unit is made of a soft material and has a sinking surface, an opposite flat surface and a flow control hole defined through a center portion thereof. In the case that the flow control means is provided in the reservoir of the housing, the flow control unit is located in a depression defined on an inner end surface of the housing, which inner end surface faces the outlet conduit, and is supported by a wheel-shaped retainer. On the other hand, in the case that the flow control means is provided in the outlet conduit, after defining a groove in a tubular passage of the outlet conduit, the flow control unit is fitted into the groove.

As a consequence, when fluid is discharged from the reservoir toward the outlet conduit, the fluid flows through the flow control hole of the flow control unit. At this time, because a fluid pressure is applied to the flow control unit, the sinking surface and the opposite flat surface are displaced in a manner such that they are reversed in their surface contours. Due to the displacement, a diameter of one end of the flow control hole, which one end faces the outlet conduit, is slightly increased, and a diameter of the other end of the flow control hole, which other end is farthest from the outlet conduit, is slightly decreased, whereby fluid flow control can be executed in a precise manner.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a manifold according to the present invention, a filter cartridge coupled to the manifold, and a structure for attaching the manifold to an electric appliance;

FIG. 2 is a side view illustrating an in-use status of the manifold according to the present invention, with the filter cartridge coupled to the manifold which is attached to the electric appliance;

FIG. 3 is a cross-sectional view taken along the line A-A of FIG. 2;

FIG. 4 is a cross-sectional view taken along the line B-B of FIG. 3;

FIG. 5 is a cross-sectional view taken along the line C-C of FIG. 3;

FIG. 6 is a cross-sectional view illustrating a course along which fluid flows into the manifold according to the present invention, passes through the filter cartridge, and is then introduced again into the manifold to be discharged;

FIGS. 7A through 7C show a second valve assembly for controlling fluid discharge and a chamber defined in an outlet conduit, wherein FIGS. 7A and 7B are cross-sectional views respectively illustrating states in which fluid flows into first and second branched outlet conduit parts and FIG. 7C is an exploded perspective view illustrating a valve seat and a flow path switchover member;

FIG. 8 is a partial enlarged cross-sectional view illustrating flow control means provided in a branched outlet conduit part; and

FIGS. 9A and 9B are cross-sectional views illustrating a structure for connecting pipes at each joint region of the manifold according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

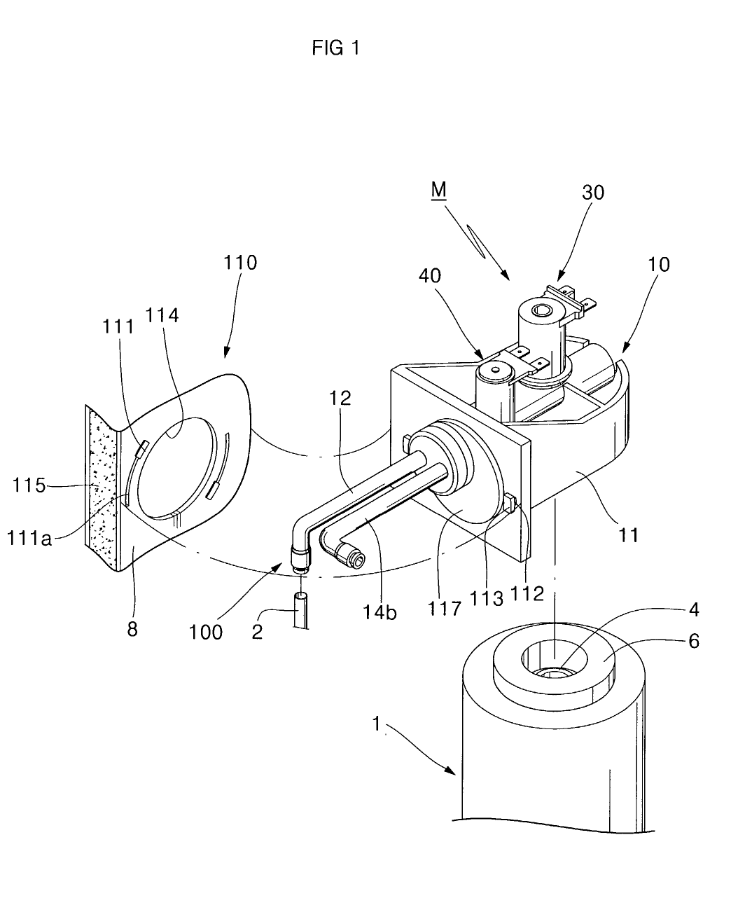

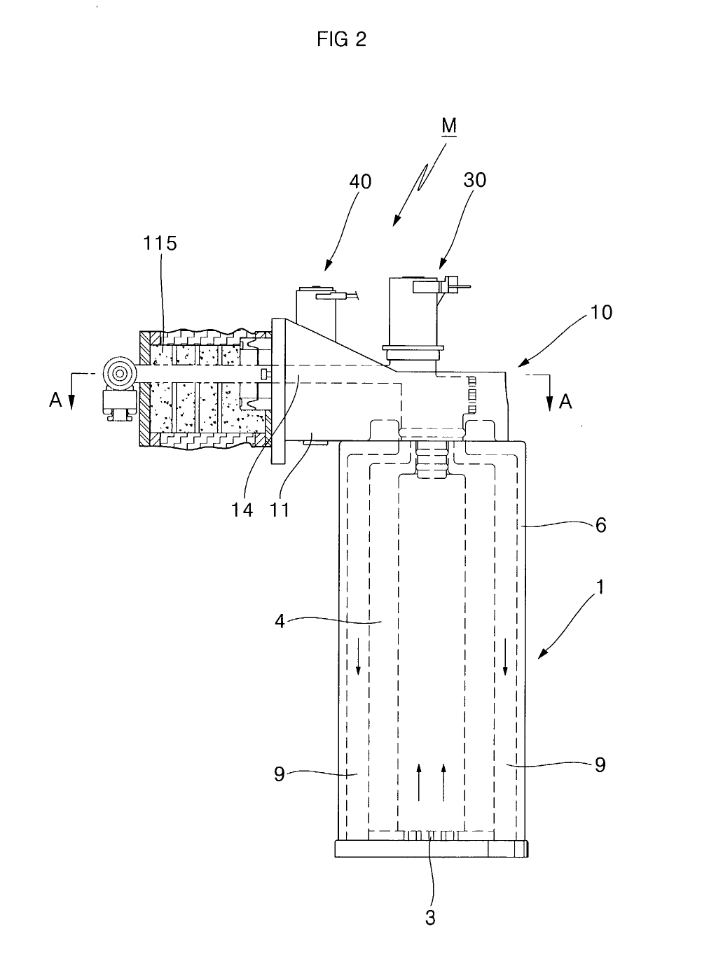

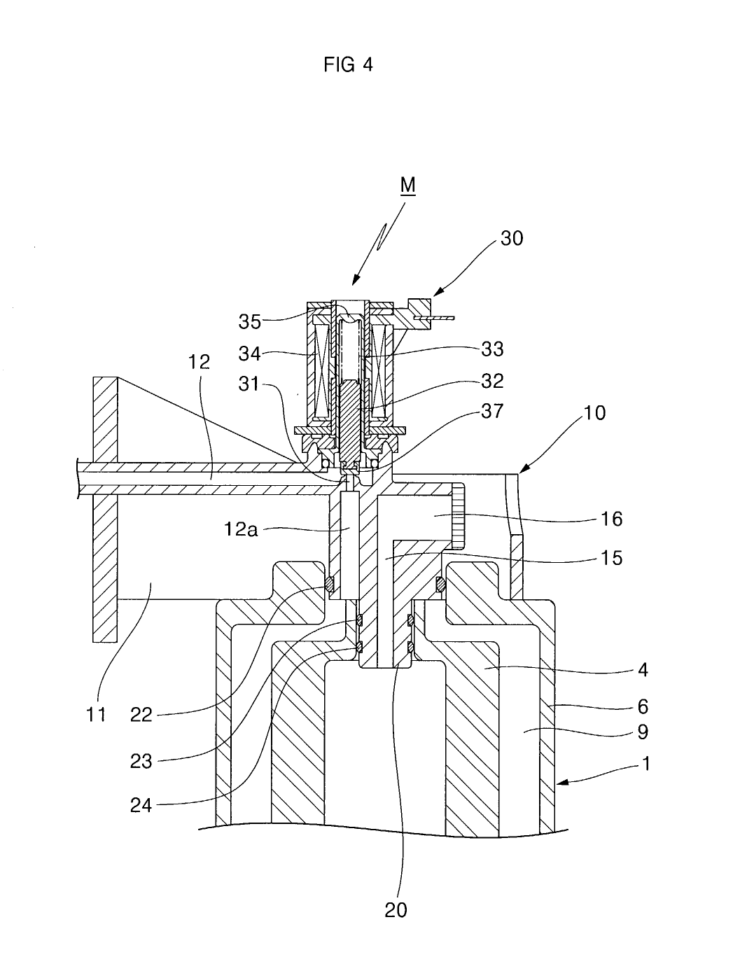

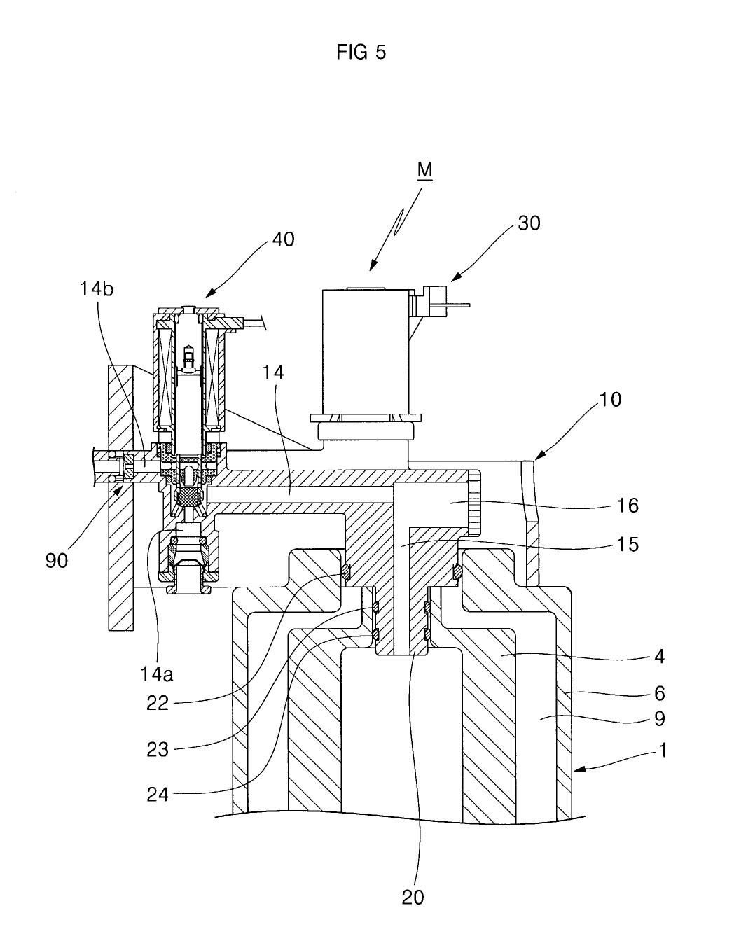

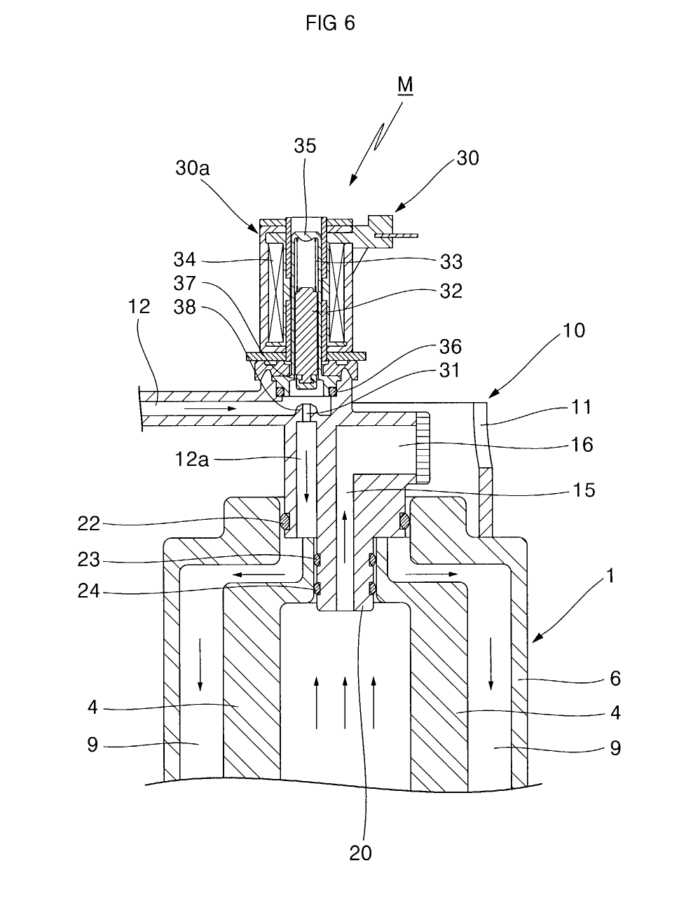

Referring to FIGS. 1, 2 and 4 through 6, a manifold M according to the present invention includes a cylindrical housing 10, an inlet conduit 12, and an outlet conduit 14. The inlet conduit 12 is connected to a water supply source by a water supply pipe 2 such as waterworks. If water is supplied through the inlet conduit 12, as shown in FIGS. 2 and 6 by arrows, the water flows through a flow space 9 which is defined between inner and outer cylindrical canisters 4 and 6 of a filter cartridge 1 serving as a fluid treatment device, and, after flowing through a plurality of holes 3 defined adjacent to a bottom of the filter cartridge 1, passes through a filtering substance (not shown) which is disposed in the inner cylindrical canister 4. Thereafter, the fluid is introduced into the housing 10 through a flow bore 15 and discharged out of the housing 10 through the outlet conduit 14. The inlet conduit 12, the flow bore 15 and a reservoir 16 defined in the housing 10 create a fluid flow channel along which fluid is introduced into the housing 10 through the filter cartridge 1.

First and second valve assemblies 30 and 40 are installed in the inlet and outlet conduits 12 and 14, respectively, to control fluid flow through the inlet and outlet conduits 12 and 14. The inlet conduit 12 of the manifold M is connected with the water supply pipe 2 by a pipe jointing assembly 100, as will be described later in detail. The outlet conduit 14 is communicated with the fluid flow channel to receive fluid discharged from the housing 10.

The manifold M according to the present invention is used in a state wherein it is attached to a wall 8 of an appliance such as a refrigerator. The manifold M can be easily attached to and detached from the wall 8 by virtue of a fixing unit 110. The fixing unit 110 includes a pair of heads 113 which are provided on a frame 11 of the manifold M, a pair of shank portions 112 for respectively supporting the heads 113, and a circular plate 117. The wall 8 of the appliance is defined with a pair of curved slits 111a which are opposite to each other and have enlarged slit portions 111, and an opening 114 for receiving the circular plate 117. The pair of slits 111a generally define a circular figure.

When fixing the manifold M to the appliance, by fitting the heads 113 into the enlarged slit portions 111 and then rotating the manifold M in a counterclockwise direction, the manifold M is attached to the wall 8 by the medium of the shank portions 112 inserted into the curved slits 111a. At this time, as the circular plate 117 is fitted into the opening 114, a fixed state of the manifold M can be stably maintained. An adiabatic material 115 is interposed between the inlet conduit 12 and the outlet conduit 14.

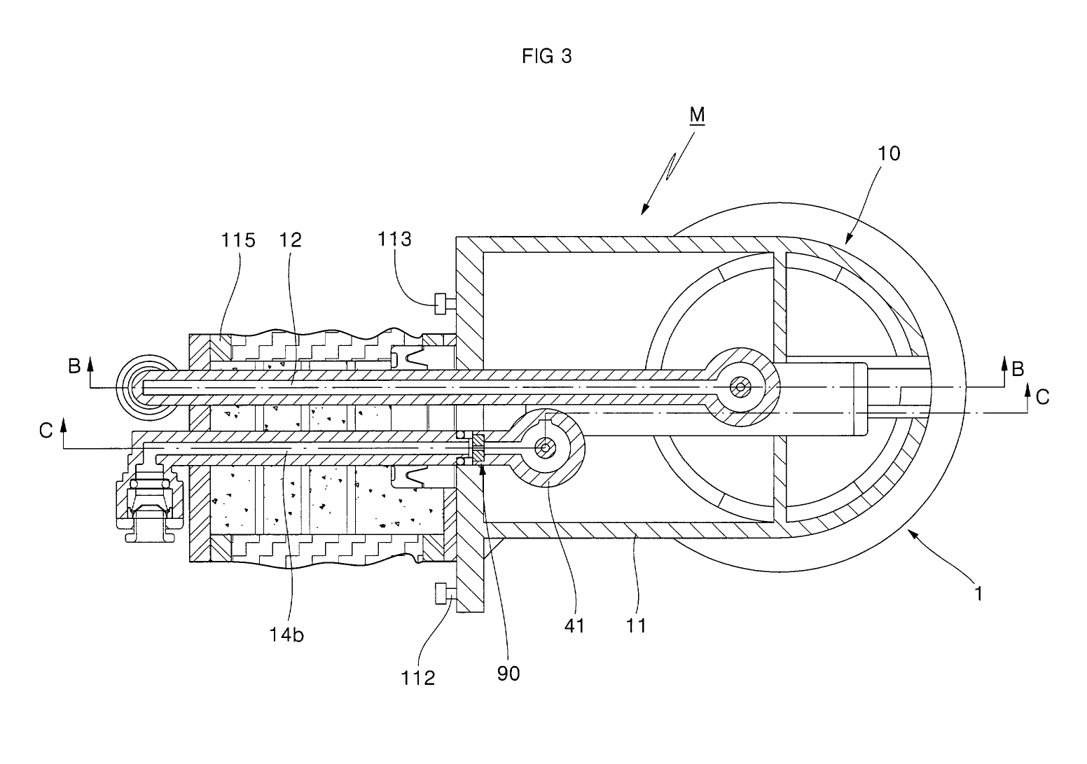

Referring to FIGS. 3 through 6, it is to be readily understood that the manifold M has the housing 10 and the inlet conduit 12 which is fixed to a side wall of the housing 10 and is formed to extend by a substantial length. The inlet conduit 12 has a bent portion 12a which is substantially perpendicularly downwardly bent in relation to an entrance of the inlet conduit 12. The first valve assembly 30 is provided at a point where the inlet conduit 12 and the bent portion 12a meet each other. The first valve assembly 30 includes an electromagnetic valve. A solenoid 30a has a casing 35, a movable member 32 provided in the casing 35, and a spring 33. A coil 34 functions to create a magnetic field in response to an electric signal and thereby move the movable member 32. An O-ring 36 is provided to prevent water leakage. The movable member 32 is provided with a valve head 37, and a valve seat 38 is defined with an inlet aperture 31. In the first valve assembly 30, a portion of the inlet conduit 12 serves as a valve body.

A lower part of the housing 10 of the manifold M is provided with a fitting portion 20 which projects downward. Also, an upper part of the housing 10 is defined with the reservoir 16. Due to the fact that the flow bore 15 is defined through the fitting portion 20, the filter cartridge 1 and the reservoir 16 are communicated with each other.

In the case that the filter cartridge 1 which is designed to have a double-staged flange structure is coupled to the manifold M according to the present invention, the lower part of the housing 10, including the bent portion 12a of the inlet conduit 12, is fitted into the outer cylindrical canister 6 of the filter cartridge 1, and the fitting portion 20 of the housing 10 is fitted into the inner cylindrical canister 4 of the filter cartridge 1. In order to ensure that the inlet aperture 31 of the inlet conduit 12 is opened to allow fluid to flow through the inlet conduit 12 into the filter cartridge 1, a controller (not shown) can be configured in a manner such that an electric ON signal is applied to the electromagnetic valve 30a, for example, when the filter cartridge 1 is coupled to the manifold M. If the inlet aperture 31 is opened in response to application of the ON signal, fluid flows through the inlet conduit 12 and the bent portion 12a into the flow space 9 of the filter cartridge 1. Then, fluid is filtered while passing through the filtering substance which is disposed in the inner cylindrical canister 4 of the filter cartridge 1. O-rings 22, 23 and 24 are provided around the fitting portion to prevent water leakage.

Thereafter, filtered water is introduced from the inner cylindrical canister 4 through the flow bore 15 of the fitting portion 20 into the reservoir 16 of the housing 10. Therefore, a predetermined amount of fluid is stored in the reservoir 16.

On the other hand, if the filter cartridge 1 is decoupled from the manifold M, as an electric signal is no longer applied to the coil 34 of the solenoid 30a (to be maintained in an OFF state), the spring 33 pushes downward the movable member 32. As a consequence, the valve head 37 is seated on the valve seat 38 to close the inlet aperture 31. In this way, upon changing the filter cartridge 1, water leakage is prevented by cooperation between the first valve assembly 30 and the filter cartridge 1.

In succession, referring to FIGS. 3 through 7, fluid flows from the reservoir 16 into the outlet conduit 14 which extends substantially parallel to the inlet conduit 12, to then be finally supplied to a destination device, for example, an ice making section or a cooling section of a refrigerator. A person skilled in the art will readily recognize that the number of outlet conduits may vary depending upon a use of the manifold. Also, it can be envisaged that the outlet conduit 14 extends in a reverse direction to the inlet conduit 12. A chamber 41 is defined at a distal end of the outlet conduit 14, and the second valve assembly 40 is provided in the chamber 41.

Describing a relationship between the chamber 41 defined in the outlet conduit 14 and the second valve assembly 40 disposed in the chamber 41 with reference to FIGS. 3, 5 and 7A through 7C, the distal end of the outlet conduit 14 which is distant from the housing 10 is divided into first and second outlet conduit parts 14a and 14b, and pipe jointing assemblies 100 are provided to joint pipes to the first and second outlet conduit parts 14a and 14b, as will be described later in detail. The distal end of the outlet conduit 14 to which the pipe jointing assemblies 100 are provided serves as a valve box or a valve body for the second valve assembly 40. A plurality of ports 14P can be provided to the distal end of the outlet conduit 14 to supply fluid in various directions.

The distal end of the outlet conduit 14 serving as the valve body is defined with the chamber 41 which has a plurality of stepped shoulders. The valve device disposed in the chamber 41 performs a function of a multi-port connecting device. A tapered projection 42 is formed on a bottom surface of the chamber 41 to serve as a valve seat, and an outlet aperture 43 is defined through the tapered projection 42.

A sealing block 50 which generally has a drum-shaped configuration is placed in the chamber 41. The sealing block 50 is defined, at a middle portion and on a circumferential outer surface thereof, with an annular recess 51. Also, the sealing block 50 is defined, on an upper surface thereof, with a receiving groove 52. A pair of guide holes 54 which extend in a longitudinal direction are defined through a bottom of the receiving groove 52. A T-shaped flow path 56 is defined in the sealing block 50 below the receiving groove 52 and adjacent to the guide holes 54. O-rings 57, 58 and 59 are provided to prevent water leakage.

The second valve assembly 40 includes a flow path switchover member 60. The flow path switchover member 60 has a hollow cylindrical body 61, a pair of bars 62 which extend upward from an upper end of the hollow cylindrical body 61, and a pair of holes 64 which are defined through opposite sides of the hollow cylindrical body 61. When the flow path switchover member 60 is coupled with the sealing block 50, the bars 62 of the flow path switchover member 60 are respectively inserted through the guide holes 54 of the sealing block 50 in a manner such that the bars 62 can be slidingly moved upward and downward in the guide holes 54. In a state wherein the flow path switchover member 60 and the sealing block 50 are coupled with each other, the holes 64 of the flow path switchover member 60 are communicated with the chamber 41.

A stopcock 66 having a cross-shaped sectional configuration is fitted into a lower end of the flow path switchover member 60. A height of the stopcock 66 is determined in a manner such that the stopcock 66 does not block the holes 64 upon being fitted into the flow path switchover member 60. The flow path switchover member 60 into which the stopcock 66 is fitted is supported by a spring 70. Here, elastic force of the spring 70 is set to be larger than that of a spring 82 arranged in a solenoid 80, in a manner such that, when a magnetic field is not created in the solenoid 80, the flow path switchover member 60 is not moved downward by being pressed by a movable member 81.

The second valve assembly 40 includes an electromagnetic valve. The solenoid 80, that is, an actuator serving as the electromagnetic valve has the movable member 81, a fixed member 84, and the spring 82 which is interposed between the movable and fixed members 81 and 84. A coil 86 provided to the solenoid 80 creates a magnetic field in response to application of an electric signal to move the movable member 81.

A pair of pipe jointing assemblies 100 are provided in the distal end of the outlet conduit 14 in which the second valve assembly 40 is disposed and which is divided into the first and second outlet conduit parts 14a and 14b, as will be descried later in detail. As a consequence, fluid flows from the housing 10 of the manifold M through the outlet conduit 14 and is then discharged into the first or second outlet conduit part 14a or 14b by way of the second valve assembly 40.

Describing operations of the manifold M according to the present invention, constructed as mentioned above, with reference to FIGS. 3 through 7, generation of ON and OFF control signals in association with operations of the first and second valve assemblies 30 and 40 can be effected depending upon coupling or decoupling of the filter cartridge 1 to or from the manifold M. Accordingly, it can be contemplated that, when the filter cartridge 1 is coupled to the manifold M, an electric signal is generated by the controller to operate the first and second valve assemblies 30 and 40. In this connection, in a preferred embodiment of the present invention, the first and second valve assemblies 30 and 40 are configured in a manner such that they are reversely operated to each other by an electric signal generated when the filter cartridge 1 is coupled to the manifold M. That is to say, it can be envisaged that, by an electric signal generated upon coupling the filter cartridge 1 to the manifold M, the solenoid 30a of the first valve assembly 30 is maintained in an ON state and the solenoid 80 of the second valve assembly 40 is maintained in an OFF state. By configuring the first and second valve assemblies 30 and 40 as described above in a manner such that they are normally reversely operated to each other unless a separate interrupt signal is applied, it is possible to prevent freezing of the ice making apparatus and avoid a water hammer phenomenon, as will be described later in detail.

By an electric signal which is generated upon coupling the filter cartridge 1 to the manifold M, the solenoid 30a of the first valve assembly 30 creates a magnetic field in the coil 34, and thereby, the movable member 32 is moved upward. As the movable member 32 is moved upward while overcoming elastic force of the spring 33, the inlet aperture 31 is opened. As the inlet aperture 31 is opened, fluid flows from the inlet conduit 12 through the bent portion 12a into the flow space 9 defined in the filter cartridge 1 and is changed in its flow direction at the holes 3. After passing through the filtering substance which is disposed in the inner cylindrical canister 4 of the filter cartridge 1, the fluid is introduced through the flow bore 15 into the reservoir 16 of the housing 10 and is then discharged into the outlet conduit 14.

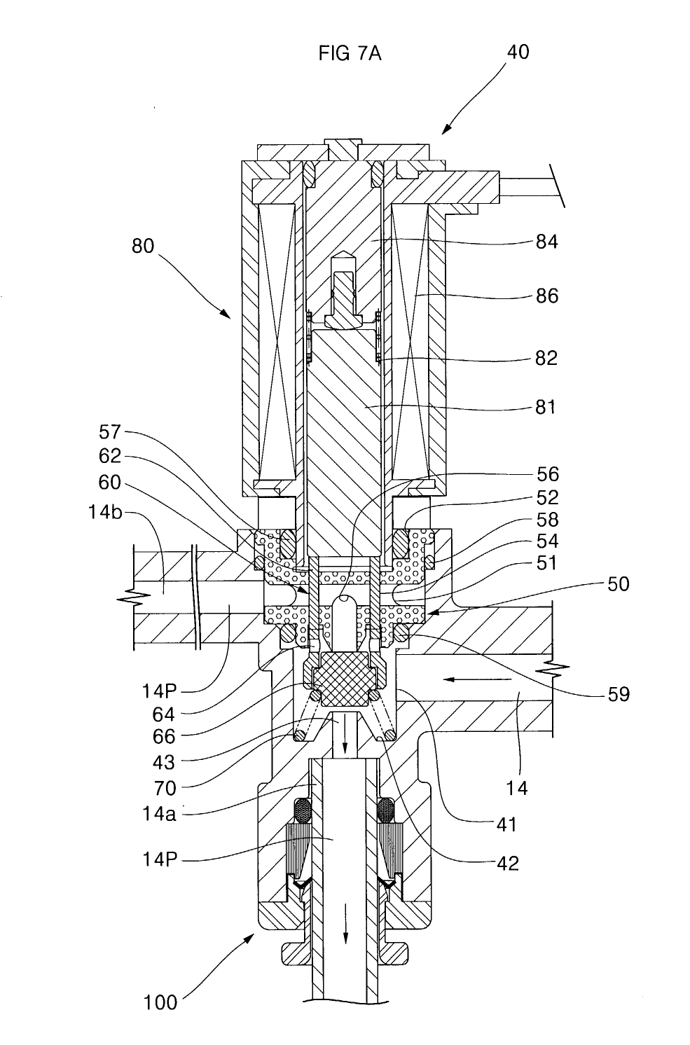

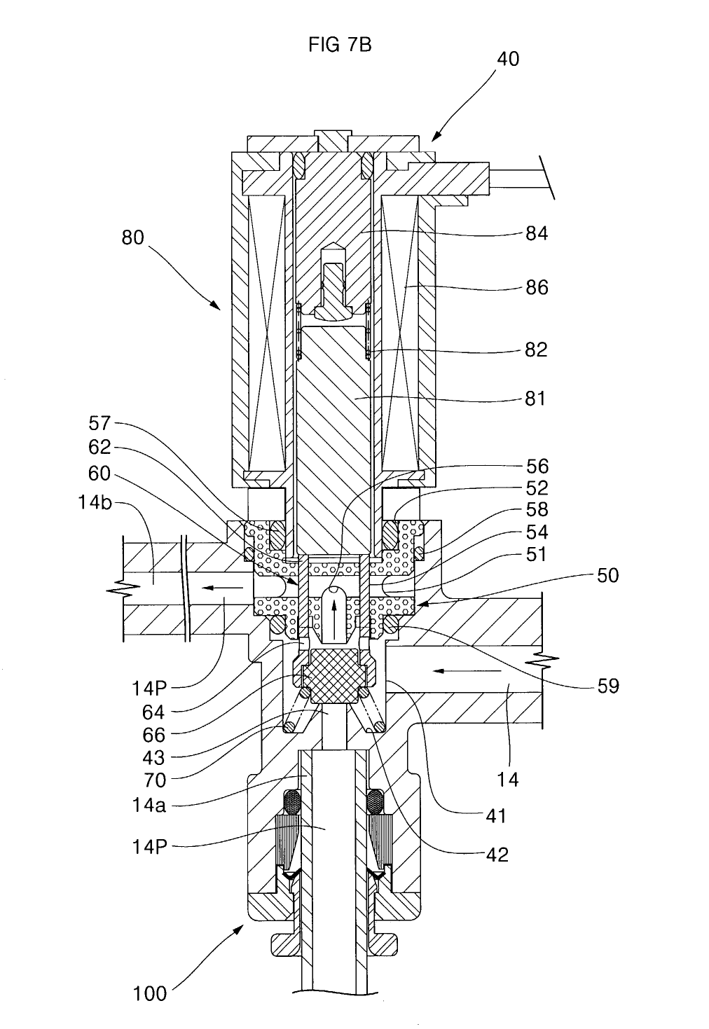

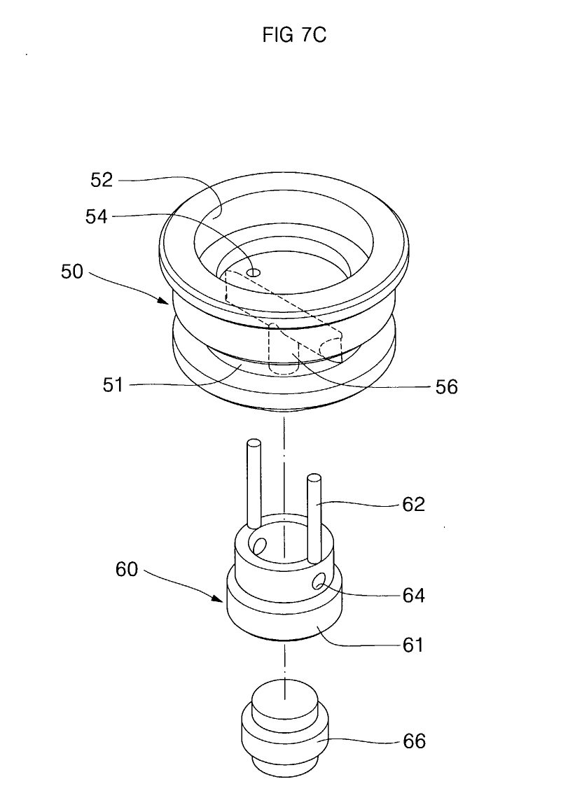

At this time, as can be readily seen from FIG. 7A, since the solenoid 80 of the second valve assembly 40 is maintained in the OFF state, the movable member 81 is held stopped. At this time, due to the fact that the elastic force of the spring 70 supporting the flow path switchover member 60 is larger than that of the spring 82 which is arranged between the movable and fixed members 81 and 84 in the solenoid 80, the movable member 81 cannot downwardly move the bars 62 of the flow path switchover member 60. Accordingly, an upper surface of the stopcock 66 of the flow path switchover member 60 closes an entrance to the T-shaped flow path 56 of the sealing block 50 and opens the outlet aperture 43 of the chamber 41. Therefore, fluid is discharged through the outlet conduit 14 into the first branched outlet conduit part 14a.

With the filter cartridge 1 coupled to the manifold M, while fluid is continuously supplied, if it is required to divert fluid flow from the first branched outlet conduit part 14a into the second branched outlet conduit part 14b, as a separate signal is applied from the controller, the solenoid 80 of the second valve assembly 40 is converted into the ON state and current flows through the coil 86, whereby the movable member 81 is moved downward. Namely, as can be readily seen from FIG. 7B, the movable member 81 is moved downward by electromagnetic force. By this fact, as the bars 62 of the flow path switchover member 60 are pressed, the flow path switchover member 60 is also moved downward against elastic force of the spring 70. Hence, the stopcock 66 of the flow path switchover member 60 closes the outlet aperture 43 of the chamber 41.

If the outlet aperture 43 of the chamber 41 is closed, fluid flowing into the chamber 41 through the outlet conduit 14 is discharged through the holes 64 of the flow path switchover member 60 and the T-shaped flow path 56 of the sealing block 50 into the second branched outlet conduit part 14b.

While fluid flows into the second branched outlet conduit part 14b, if the application of the electric signal from the controller is interrupted or the filter cartridge 1 is decoupled from the manifold M, the solenoid 80 of the second valve assembly 40 is switched to the OFF state. Thereby, as shown in FIG. 7A, the flow path switchover member 60 is moved upward by elastic force of the spring 70 to close the T-shaped flow path 56 of the sealing block 50, whereby fluid is discharged into the first branched outlet conduit part 14a.

In the manifold M according to the present invention, by causing the first and second valve assemblies 30 and 40 to be reversely operated to each other and thereby controlling fluid flow through the fluid supply lines, in the case of using the present manifold M along with the ice making apparatus, it is possible to prevent the conduits from being frozen. That is to say, describing the case that a refrigerator is used as the appliance, the refrigerator needs water to be used for a cooling section and an ice making section. In this regard, in the manifold M according to the present invention, the first outlet conduit part 14a is connected to the cooling section, and the second outlet conduit part 14b is connected to the ice making section. Thus, if the filter cartridge 1 is coupled to the manifold M, fluid flows from the inlet conduit 12 into the filter cartridge 1 and is then introduced into the reservoir 16 of the housing 10. Then, the fluid flows through the outlet conduit 14 and enters the chamber 41. At this time, since the outlet aperture 43 is maintained in an opened state, the fluid is discharged through the first branched outlet conduit part 14a into the cooling section. If the solenoid 80 of the second valve assembly 40 is converted into the ON state by application of a separate electric signal from the controller, the flow path switchover member 60 closes the outlet aperture 43, and fluid is discharged into the second branched outlet conduit part 14b. If the signal application from the controller is interrupted or the filter cartridge 1 is decoupled from the manifold M, the solenoid 80 of the second valve assembly 40 is switched to the OFF state, and fluid flow into the second branched outlet conduit part 14b is shut off.

As described above, since fluid flow into the second branched outlet conduit part 14b is permitted only upon an active request by signal application, when an amount of fluid flowing through the second branched outlet conduit part 14b into the ice making section is decreased due to a pressure decrease by change in fluid amount as it occurs where the filter cartridge 1 is decoupled from the manifold M, it is possible to prevent the second branched outlet conduit part 14b and surrounding arrangements from being frozen.

While it was described that the first and second valve assemblies 30 and 40 are configured to be reversely operated to each other, it is to be noted that this description is given only for illustrative purposes. Therefore, in the case that fluid is to be normally discharged through the second branched outlet conduit part 14b, the first and second valve assemblies 30 and 40 are configured to be simultaneously operated with each other so that they are commonly maintained in the ON state or OFF state.

By configuring the first and second valve assemblies 30 and 40 in a manner such that they are normally reversely operated to each other to control fluid flow through the fluid supply lines unless a separate interrupt signal is applied, it is possible to avoid a water hammer phenomenon. When the first valve assembly 30 is energized or deenergized, a corresponding operation for the second valve assembly 40 is delayed by a predetermined time interval, whereby fluid shock due to abrupt inflow or outflow from the filter cartridge 1 into or from the conduits 12, 14, 14a and 14b of the manifold M is avoided.

As described above, in the manifold M according to the present invention, the flow parts or passages for inflow and outflow of fluid are provided in the shape of conduits. For this reason, it is possible to secure a space such as the reservoir 16 in the housing 10 of the manifold M, and flow control means 90 can be provided to the secured space, that is, reservoir 16, as will be described later in detail. Further, because it is possible to install in the conduits 12, 14, 14a and 14b the valve assemblies or means capable of controlling inflow and outflow of fluid, not only can valve assembly installing operations be easily executed, but also necessary measures can be taken even in the case of breakdown of the valve assemblies.

Moreover, the port or chamber 41 can be formed in each course of the inlet and outlet conduits 12, 14, 14a and 14b. Using this chamber 41, a valve assembly can be installed, and various mechanisms capable of controlling fluid flow can be provided. Therefore, by forming the chamber 41 in each of the conduits 12, 14, 14a and 14b and installing the valve assembly in the chamber 41, the pipe jointing means or assemblies 100 can be utilized to easily joint and disjoint conduits with and from one another.

Referring to FIGS. 3 through 8, specifically, 8, the flow control means 90 is selectively provided in the reservoir 16 of the housing 10, the outlet conduit 14, the first branched outlet conduit part 14a or the second branched outlet conduit part 14b. In this preferred embodiment of the present invention, the flow control means 90 is provided to the second branched outlet conduit part 14b. The flow control means 90 has a disc-shaped flow control unit 91. The flow control unit 91 is made of a material having a predetermined flexibility in a manner such that the flow control unit 91 can be displaced by a pressure change of fluid flowing through the second branched outlet conduit part 14b.

The flow control unit 91 has a gradually curved and sinking surface 92 which is distant from the second valve assembly 40, and a flat surface which is opposite to the gradually curved and sinking surface 92. A flow control hole 93 is defined through a center portion of the flow control unit 91.

An annular groove 94 is defined on a circumferential inner surface of the second branched outlet conduit part 14b, and the flow control unit 91 is fitted into the annular groove 94.

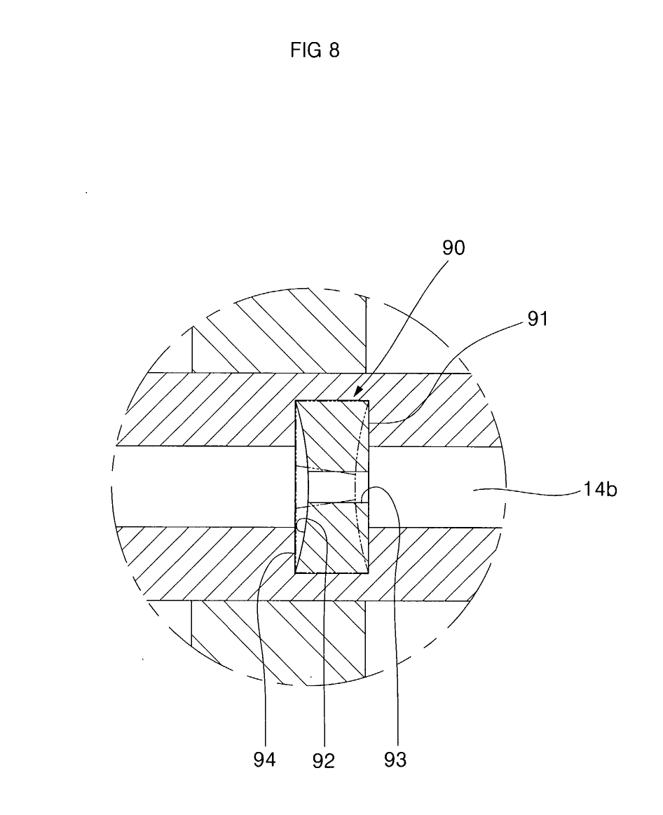

When fluid does not flow from the reservoir 16 of the housing 10 through the second valve assembly 40 into the second branched outlet conduit part 14b, the flow control unit 91 is maintained in an initially installed state. That is to say, the gradually curved and sinking surface 92 which is distant from the second valve assembly 40 is maintained in a curved and sinking state, and the opposite flat surface is maintained in a flattened state. On the other hand, if fluid starts to flow from the reservoir 16 of the housing 10 into the second branched outlet conduit part 14b, as a fluid pressure is applied to the flat surface of the flow control unit 91 while fluid flows through the flow control hole 93, the gradually curved and sinking surface 92 of the flow control unit 91 made of a flexible material is moved forward to be flattened and then comes into surface contact with a front surface (a left surface in FIG. 8) of the annular groove 94. On the other hand, as the flat surface opposite to the sinking surface 92 is gradually depressed, the flow control unit 91 experiences displacement.

The flow control hole 93 is influenced by the displacement in which the gradually curved and sinking surface 92 and opposite flat surface of the flow control unit 91 are reversed in their surface contours. Hence, by the fact that the sinking surface 92 is transformed from a curved surface to a flat surface by fluid flow through the flow control hole 93, a diameter of one end of the flow control hole 93, which one end is distant from the second valve assembly 40, is slightly increased. On the contrary, a diameter of the other end of the flow control hole 93, which other end faces the second valve assembly 40, is slightly decreased. As a result, the flow control hole 93 generally has a funnel-shaped configuration. In the case that fluid does not flow through water supply lines due to decoupling of the filter cartridge 1 from the manifold M, the flow control unit 91 is returned to its original state. In this way, fluid flow control can be executed by the flow control means 90 in the second branched outlet conduit part 14b in correspondence to fluid flow and fluid flow interruption.

Of course, a degree to which a diameter of the flow control hole 93 of the flow control unit 91 is changed may be varied depending upon a size of an appliance employing the manifold M. In other words, in the case that a diameter of the outlet conduits 14, 14a and 14b of the manifold M is large, a size of the flow control unit 91 and a diameter of the flow control hole 93 are increased, and vice versa. Accordingly, the flow control means 90 according to the present invention is able to control fluid flow in conformity with a given situation.

In the manifold M according to the present invention, since inlet and outlet passages are defined in the shape of conduits, at any position, the conduits 12, 14, 14a and 14b can be easily branched to extend toward desired places and can be easily jointed with other fluid supply pipes. That is to say, the pipe jointing assembly 100 capable of being easily jointed and disjointed can be used to connect the inlet conduit 12 with the water supply pipe 2 as shown in FIG. 1 and to branch and joint the outlet conduits 14, 14a and 14b with other fluid supply pipes as shown in FIGS. 3 through 7.

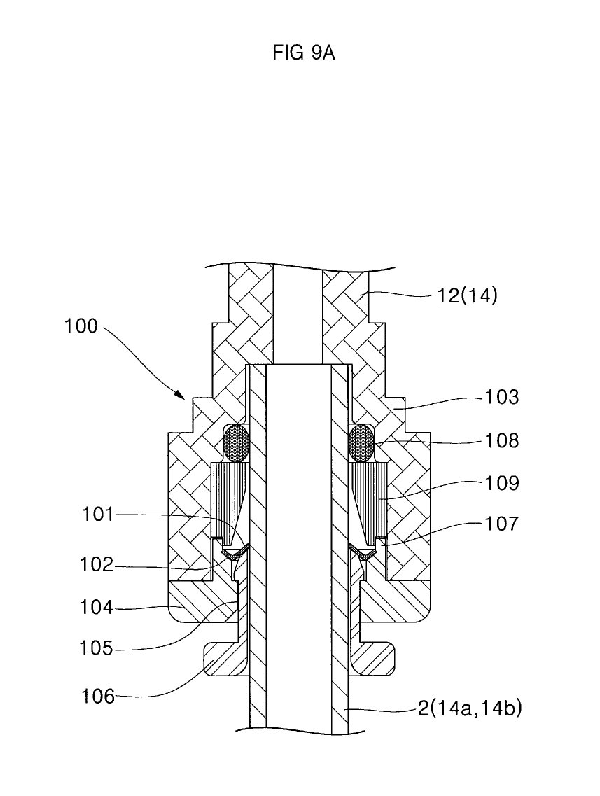

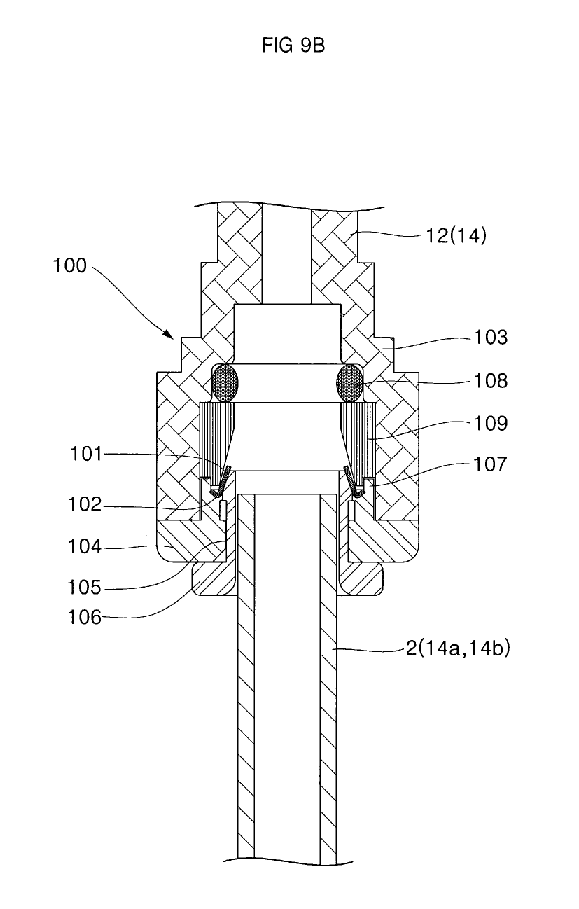

FIG. 9A illustrates a state wherein two pipes are connected with each other, and FIG. 9B illustrates another state wherein two pipes are disconnected from each other. Describing, for example, the case that the inlet conduit 12 and the water supply pipe 2 are connected with each other, a coupling end portion 103 of the inlet conduit 12 has a plurality of stepped surfaces on which various component elements are disposed. The pipe jointing assembly 100 includes a pipe fastening member 102. The pipe fastening member 102 has an annular frame portion and a plurality of elastic supporting fragments 101 integrally extending from the annular frame portion. Also, the pipe jointing assembly 100 is provided with a cylindrical fixing cap 104. The cylindrical fixing cap 104 has a head and a shoulder 107 for holding the pipe fastening member 102. The fixing cap 104 is defined with a center hole 105 through which the inlet conduit 12 can be inserted. The pipe jointing assembly 100 further includes an unlocking member 106 for allowing the inlet conduit 12 and the water supply pipe 2 to be decoupled from each other, and a holder 109 which has an inclined surface for keeping the pipe fastening member 102 from being released upon decoupling the inlet conduit 12 and the water supply pipe 2 from each other. Further, an O-ring 108 is provided to prevent water leakage.

When the inlet conduit 12 and the water supply pipe 2 are connected with each other, as shown in FIG. 9A, by pushing the water supply pipe 2 into the inlet conduit 12, the water supply pipe 2 is inserted into the inlet conduit 12 while overcoming force of the elastic supporting fragments 101 of the pipe fastening member 102 until a free end of the water supply pipe 2 is brought into contact with an innermost stepped surface which is formed in the coupling end portion 103 of the inlet conduit 12. Then, as the elastic supporting fragments 101 of the pipe fastening member 102 radially apply force to the water supply pipe 2, the water supply pipe 2 is reliably held coupled to the inlet conduit 12.

When the inlet conduit 12 and the water supply pipe 2 are disconnected from each other, as shown in FIG. 9B, by pushing the unlocking member 106 into the coupling end portion 103 of the inlet conduit 12, a free end of the unlocking member 106 separates the elastic supporting fragments 101 from the water supply pipe 2, whereby it is possible to easily decouple the water supply pipe 2 from the inlet conduit 12. At this time, due to the fact that the elastic supporting fragments 101 of the pipe fastening member 102 are stably held by the inclined surface of the holder 109, the pipe fastening member 102 is kept from being released from the shoulder 107 of the fixing cap 104.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A manifold adapted for supplying fluid to a fluid treatment device and discharging treated fluid to a desired place, the manifold comprising:
an inlet conduit for allowing fluid to flow into the fluid treatment device;
a housing having a flow path for receiving fluid from the fluid treatment device;
an outlet conduit connected to the housing in such way as to be communicated with the flow path, for allowing fluid to be discharged from the housing;
a chamber defined at one end of the outlet conduit and having a plurality of ports which are communicated with the outlet conduit; and
first valve means for controlling fluid discharge through the plurality of ports of the chamber.

2. The manifold as set forth in claim 1, wherein the housing further has defined therein a reservoir for storing a predetermined amount of fluid, and the flow path is defined to be communicated with the reservoir.

3. The manifold as set forth in claim 1, wherein second valve means is disposed in the inlet conduit to control fluid flow.

4. The manifold as set forth in claim 1, wherein the plurality of ports is composed of a pair of ports.

5. The manifold as set forth in claim 3, wherein each of the first and second valve means includes an electromagnetic valve.

6. A manifold adapted for supplying fluid to a fluid treatment device and discharging treated fluid to a desired place, the manifold comprising:
an inlet conduit for allowing fluid to flow into the fluid treatment device;
a housing having a flow path for receiving treated fluid from the fluid treatment device;
an outlet conduit connected to the housing in such way as to be communicated with the flow path, for allowing fluid from to be discharged from the housing;
a chamber defined at and communicated with one end of the outlet conduit, and having first and second ports for discharging fluid; and
a valve assembly disposed in the chamber and having a sealing block, a flow path switchover member, an actuator and a spring, the sealing block being defined with a flow passage which is communicated with the first port and a pair of guide holes, the flow path switchover member having a body, a pair of bars which extend upward from the body and are slidably inserted through the guide holes of the sealing block, and a pair of holes which are defined through opposite sides of the body to be communicated with the chamber;
wherein, when the actuator is not operated, the spring supports the flow path switchover member in a manner such that the flow passage communicated with the first port is closed; and, when the actuator is operated, the actuator presses and moves downward the bars of the flow path switchover member against elastic force of the spring in a manner such that the second port is closed, whereby the actuator selectively opens and closes the second port and the flow passage communicated with the first port to control fluid flow through the first and second ports.

7. The manifold as set forth in claim 6, wherein the housing further has defined therein a reservoir for storing a predetermined amount of fluid, and the flow path is defined to be communicated with the reservoir.

8. The manifold as set forth in claim 6, wherein the actuator includes a solenoid which is operated by an electric signal.

9. The manifold as set forth in claim 6, wherein the body of the flow path switchover member possesses a hollow cylindrical configuration, and further has a stopcock which is fitted into the body, to open and close the flow passage and the second port when the flow path switchover member is moved by the actuator and the spring.

10. The manifold as set forth in claim 6, further comprising:
valve means provided in the inlet conduit to control fluid flow through the inlet conduit.
